(19) United States
(12) Patent Application Publication
(10) Pub. No.: US 2015/0147961 A1
(43) Pub. Date: May 28, 2015

(54) Content Retrieval via Remote Control

(71) Applicant: Google Inc., Mountain View, CA (US)

(72) Inventors: Joe Freeman Britt, JR., Los Altos, CA (US); Christopher David McKillop, Palo Alto, CA (US)

(73) Assignee: Google Inc., Mountain View, CA (US)

(21) Appl. No.: 13/946,153

(22) Filed: Jul. 19, 2013

(51) Int. Cl. H04B 5/00

(52) U.S. Cl. CPC H04B 5/0031
USPC 455/41.1

(57) ABSTRACT

Methods and systems for retrieving content on a content activation device are provided. A method includes connecting to a mobile device by a near field communication (NFC) connection. An indication of content being displayed on the mobile device may be received via the NFC connection. An instruction to retrieve a version of the content being displayed on the mobile device, from a source distinct from the mobile device may be transmitted via a wireless connection, to a content activation device. Additionally, a method includes connecting, by a mobile device, to a remote control by a near field communication (NFC) connection. An instruction to retrieve a first content displayed on the mobile device may be transmitted to the remote control. The instruction to retrieve the first content may be for a first version of the first content different from a second version of the first content displayed on the mobile device.

### BACKGROUND

Content activation devices or entertainment devices such as TVs, speakers, set-top boxes, docks, appliances, DVD players, car audio systems, game consoles, and the like, are more often being used for consumption of other content, such as shared content as well as internet and cloud-based service content. However, consuming content on these entertainment devices can be cumbersome and challenging. In particular, sharing content with these entertainment devices from mobile devices can be difficult because establishing a connection (wired or wireless) between the devices can be burdensome.

### BRIEF SUMMARY

According to an implementation of the disclosed subject matter, a method includes connecting to a mobile device by a near field communication (NFC) connection. An indication of content being displayed on the mobile device may be received via the NFC connection. Next, an instruction to retrieve a version of the content being displayed on the mobile device, from a source distinct from the mobile device may be transmitted via a wireless connection, to a content activation device.

According to an implementation of the disclosed subject matter, a method includes connecting, by a mobile device, to a remote control by a near field communication (NFC) connection. An instruction to retrieve a first content displayed on the mobile device may be transmitted to the remote control. The instruction to retrieve the first content may be for a first version of the first content different from a second version of the first content displayed on the mobile device.

An implementation of the disclosed subject matter provides a system that includes a processor configured to connect to a mobile device by a near field communication (NFC) connection. An indication of content being displayed on the mobile device may be received via the NFC connection. Next, an instruction to retrieve a version of the content being displayed on the mobile device, from a source distinct from the mobile device may be transmitted, via a wireless connection to a content activation device.

An implementation of the disclosed subject matter provides a system that includes a processor configured to connect, by a mobile device, to a remote control by a near field communication (NFC) connection. An instruction to retrieve a first content displayed on the mobile device may be transmitted to the remote control. The instruction to retrieve content may be for a first version of the first content different from a second version of the first content displayed on the mobile device.

Implementations of the disclosed subject matter may allow for easier sharing of content between devices and provide a simpler way to communicate with entertainment devices from a mobile device. The disclosed subject matter provides the entertainment device with an instruction to retrieve content from a source other than the mobile device, allowing the user of the mobile device to view other content on the mobile device without interrupting presentation of the content on the entertainment device. This may also improve the battery life of the mobile device since the mobile device is not continuously streaming content to the entertainment device. Additional features, advantages, and embodiments of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example process according to an implementation of the disclosed subject matter.

FIG. 3 shows an example information flow according to an implementation of the disclosed subject matter.

FIG. 4 shows an example information flow according to an implementation of the disclosed subject matter.

FIGS. 5A and 5B show example configurations according to an implementation of the disclosed subject matter.

FIG. 6 shows a computer according to an implementation of the disclosed subject matter.

FIG. 7 shows a network configuration according to an implementation of the disclosed subject matter.

### DETAILED DESCRIPTION

Streaming of content from one device to another device can be burdensome when a wired or wireless connection must be established between, for example, a mobile device and an entertainment device. In order to stream and/or share content between a mobile device and an entertainment device, the mobile device may need to directly connect to the entertainment device, for example by connecting to the same network on which the entertainment device or connecting to the entertainment device by other wired/wireless connection. Additionally, continuous streaming and/or sharing of content from the mobile device to the entertainment device may drain the battery life of the mobile device. In general, streaming/sharing of content from a mobile device to a television can be accomplished by a mirror mode in which content being displayed on the mobile device is simultaneously displayed on the television. However, there are some drawbacks to these content streaming/sharing features, such as mirror mode. For example, a user may be watching a movie with his friends by wirelessly streaming the movie from his phone to a television in mirror mode via a wireless connection protocol. While streaming in mirror mode, the phone battery may begin to run low and the user may have to pause streaming of the movie and/or inconveniently connect the phone to a power source. Additionally, while streaming, the user may wish to view content other than the movie on his mobile device; for example, he may wish to check his email. However, if he were to access his email inbox on his phone while in mirror mode, his email inbox would be displayed on the television, and he may not want his friends viewing the movie to see the contents of his email inbox.

As another example, Alice may be visiting Bob's house, and she may want to show Bob her photos from her last vacation. Alice's photos may be on her mobile device and she may want to show the photos on Bob's television. In order to share the photos on her mobile device with Bob's television, Alice may have to connect her mobile device to Bob's home network (on which Bob's television is also connected) and push the photos to the television via Wi-Fi. Alternatively, Alice may have to connect her mobile device to the television via wired connection or other wireless connection protocol such as Bluetooth. In this regard, connecting Alice's mobile device to the television may be burdensome and time consuming.

However, most content activation devices, such as entertainment devices often have dedicated remote controls from which a user can easily control and interact with the entertainment device. It may be useful for a mobile device to provide content to an entertainment device via a remote control, thereby avoiding the lengthy process for establishing a connection between the entertainment and mobile devices. The presently disclosed subject matter provides a system for easily presenting content on an entertainment device based on content retrieval instructions received from a near field communications (NFC) capable remote control. The NFC remote control may receive the content retrieval instructions from a user's mobile device that is connected to the remote control via NFC, and as a result, the NFC remote control may provide the content retrieval instructions to the entertainment device. Accordingly, the entertainment device may retrieve the content based on the content retrieval instructions, and the content may be presented on the entertainment device.

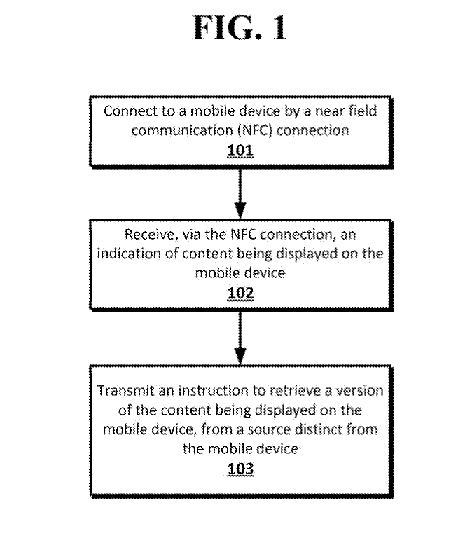

An implementation of the disclosed subject matter provides systems and methods for retrieving content on a content activation device based on instructions received from an NFC remote control. As shown in FIG. 1, a method includes an NFC remote control connecting to a mobile device by a near field communication (NFC) connection, at 101. At 102, an indication of content being displayed on the mobile device may be received via the NFC connection. Next, an instruction to retrieve a version of the content being displayed on the mobile device, from a source distinct from the mobile device may be transmitted via a wireless connection, to a content activation device, at 103.

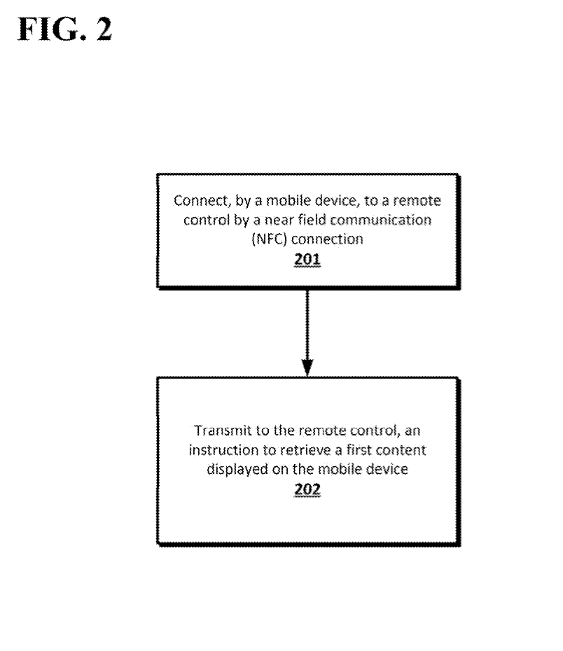

According to an implementation of the disclosed subject matter, FIG. 2 shows a method that includes connecting, by a mobile device, to a remote control by a near field communication (NFC) connection, at 201. An instruction to retrieve a first content displayed on the mobile device may be transmitted to the remote control, at 202. The instruction to retrieve the first content may be for a first version of the first content different from a second version of the first content displayed on the mobile device.

A mobile device may be a smartphone, a PDA, a handheld device, a handheld computer, a tablet, a laptop, a wearable computer, a mobile phone, and any other device capable of displaying content and connecting to a remote control via NFC connection. A content activation device may be any device capable of presenting content, such as an entertainment device. For example, a content activation device may be a set top box, a television, a dock, speakers, a DVD player, a car audio system, a game console, an appliance, and any other device that can present content and which can be controlled by a remote control. As used herein, presentation of content may include playing, displaying, activating, browsing, presenting, machine speaking, and the like, of content. Content may be any content that can be presented on a mobile device and/or a content activation device. For example, content may be a content-type including audio, video, an image, a hologram, a three-dimensional video, a program, an application, a website, a document, and social media.

A remote control may be any device used for controlling a content activation device. A remote control may control a content activation device based on a wireless connection, such as infrared, near field communications, Wi-Fi, Bluetooth, Bluetooth LE, Miracast™, or similar wireless connection protocols.

An implementation of the disclosed subject matter provides a system that includes a processor configured to connect to a mobile device by a near field communication (NFC) connection. An indication of content being displayed on the mobile device may be received via the NFC connection. Next, an instruction to retrieve a version of the content being displayed on the mobile device, from a source distinct from the mobile device may be transmitted, via a wireless connection to a content activation device.

According to an implementation of the disclosed subject matter, a system includes a processor configured to connect, by a mobile device, to a remote control by a near field communication (NFC) connection. An instruction to retrieve a first content displayed on the mobile device may be transmitted to the remote control. The instruction to retrieve content may be for a first version of the first content different from a second version of the first content displayed on the mobile device.

According to an implementation of the disclosed subject matter, a computer readable medium storing a plurality of instructions that cause a processor to connect to a mobile device by a near field communication (NFC) connection is provided. An indication of content being displayed on the mobile device may be received via the NFC connection. Next, an instruction to retrieve a version of the content being displayed on the mobile device from a source distinct from the mobile device may be transmitted via a wireless connection to a content activation device.

Additionally, an implementation of the disclosed subject matter provides a computer readable medium storing a plurality of instructions that cause a processor to connect, by a mobile device, to a remote control by a near field communication (NFC) connection. An instruction to retrieve a first content displayed on the mobile device may be transmitted to the remote control. The instruction to retrieve the first content may be for a first version of the first content different from a second version of the first content displayed on the mobile device.

As another example, Alice may be visiting Bob's house, and she may want to show Bob a video that she can access on her mobile device. For example, the video may be available from an Internet video provider. Rather than stream the video from her mobile device to Bob's television via mirror mode by connecting her mobile device to Bob's home network or Bob's television, Bob's television may have an NFC remote control that provides an alternate interface to the television. Alice may hold her mobile device within NFC range of the remote control, thereby connecting her mobile device to the remote control via NFC. Alice may begin to display the video on her mobile device, and the remote control may receive an indication, via the NFC connection, of the video being displayed on the mobile device. The remote control may send instructions to the television to retrieve the video from a source other than the mobile device; for example, the instructions may be to retrieve the video directly from the Internet video provider from which the video is available. As a result, the video may be displayed on the television. Additionally, the video being displayed on Alice's mobile device may be a mobile version of the video, while the video retrieved and displayed on the television may be a high definition (HD) version of the video. Among other advantages, the present disclosure avoids the drawbacks associated with continuous streaming in mirror mode from a mobile device. Because the video has been retrieved from a source other than Alice's mobile device, Alice is free to view other content on her mobile device while the video is being played on Bob's television, without Bob also seeing what is being displayed on Alice's device. Additionally, since Alice's mobile device is not continuously streaming the video to Bob's television, depleting of Alice's mobile device battery may be avoided.

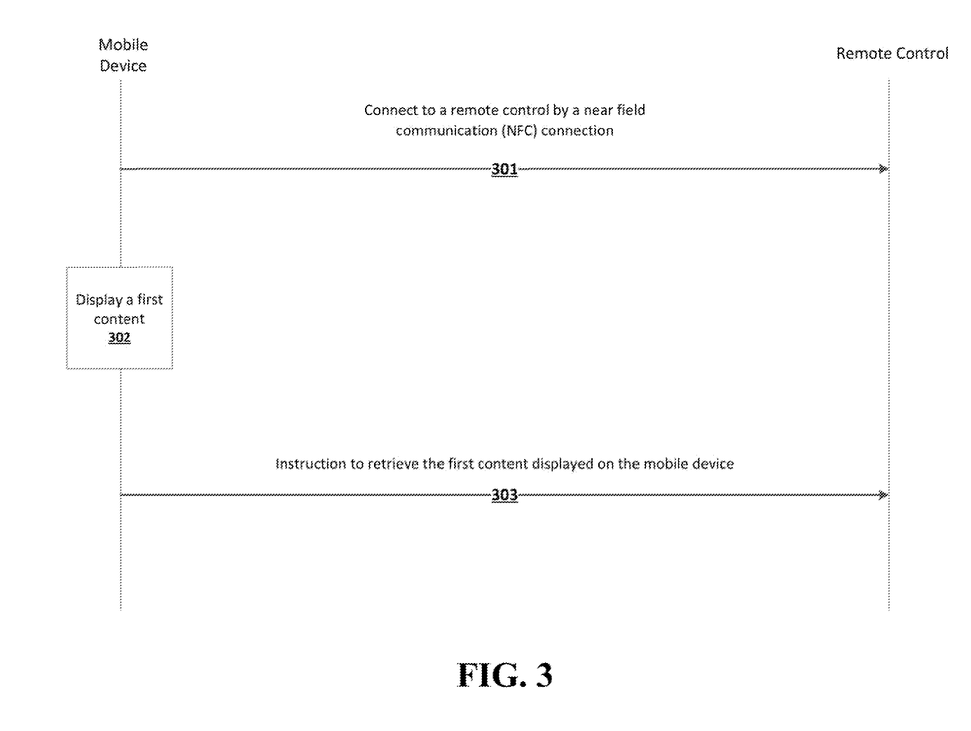

FIG. 3 shows an example information flow according to an implementation of the disclosed subject matter. As shown in FIG. 3, a mobile device may connect to a remote control by a near field communication connection, at 301. A near field communications (NFC) connection between a mobile device and a remote control may be established when the devices are in proximity of each other and within NFC communication range. For example, an NFC connection may be established when the two devices are able to establish radio communication with each other, such as by touching the two devices together or bringing them into close proximity of each other, usually no more than a few centimeters. A first content may be displayed on the mobile device, at 302. Next, at 303, the mobile device may transmit an instruction, to the remote control, to retrieve the first content displayed on the mobile device. The instruction to retrieve the first content may be for a first version of the first content different from a second version of the first content displayed on the mobile device. In an implementation, a second content, different from the first content, may be displayed on the mobile device subsequent to the step of transmitting to the remote control, an instruction to retrieve the first content displayed on the mobile device. The second content, different from the first content, may be displayed on the mobile device while the first content is displayed on a device controlled by the remote control. Additionally, in an implementation, the first content may be displayed on the mobile device before the step of connecting to a remote control by a near field communication (NFC) connection.

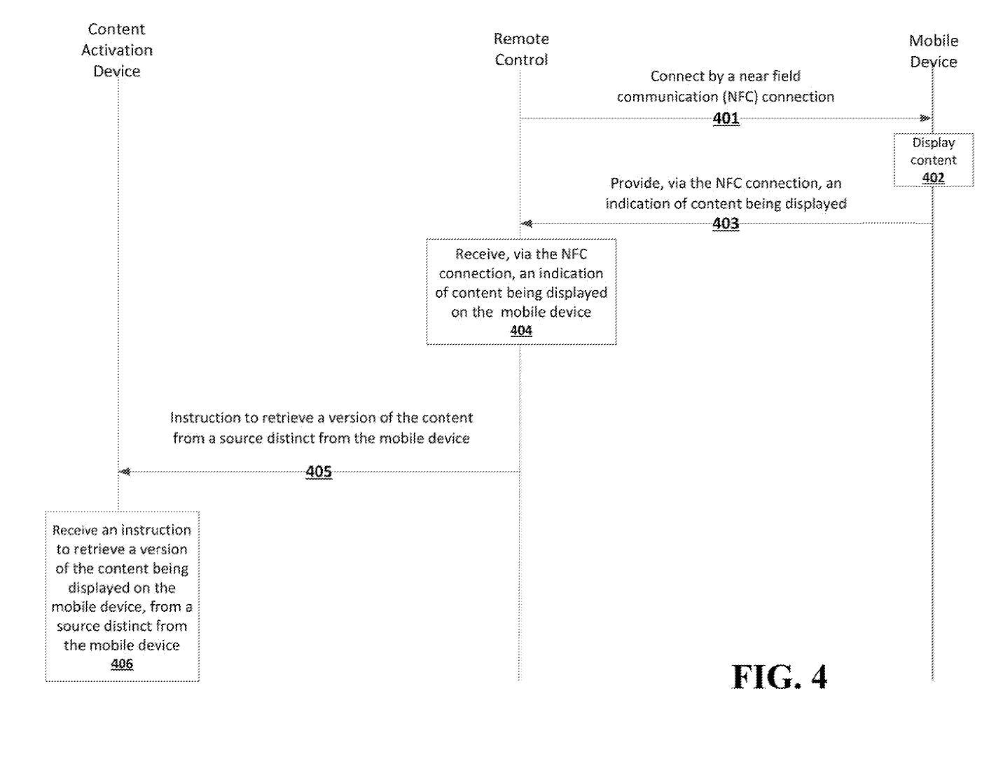

FIG. 4 shows an example information flow according to an implementation of the disclosed subject matter. As shown in FIG. 4, a remote control may connect to a mobile device by a near field communication (NFC) connection, at 401. Content may be displayed on the mobile device, at 402. Next, the mobile device may provide, via the NFC connection, to the remote control an indication of content being displayed, at 403. At, 404, the remote control may receive from the mobile device, via the NFC connection, an indication of content being displayed on the mobile device. Next, at 405, the remote control may transmit, via a wireless connection, to a content activation device an instruction to retrieve a version of the content being displayed on the mobile device. The instruction to retrieve a version of the content may be an instruction to retrieve a version of the content from a source distinct from the mobile device. At 406, the content activation device may receive, from the remote control, an instruction to retrieve a version of the content being displayed on the mobile device from a source distinct from the mobile device. As a result, the content activation device may retrieve and present a version of the content being displayed on the mobile device.

As described with respect to FIGS. 3 and 4, an instruction to retrieve a version of content different from the version of the content being displayed on the mobile device may be based on a variety of factors. For example, a specific version of content may be preferred over another version based on user preference, content activation device type, mobile device type, connection type, content source type, and content type. A version of content may include a non-mobile version, a high definition (HD) version, a full screen version, a mobile version, and a version having a format different from the format of the content being displayed on the mobile device. An HD version may be a version of content of higher resolution than is standard, for example with more than 480 horizontal lines. As an example, a website being displayed on a mobile device may be a mobile version of the website. An instruction to retrieve the website may be sent to the remote control for a television. The instruction may specify retrieval of the full site version of the website being displayed on the mobile device. For example, a user cloud-based account associated with a mobile device may include user preferences related to the versions of content. A user may prefer that the HD version of a video be played on a television when available.

A user account may be associated with a mobile device and/or a content activation device. A user account may include various information including user profile, user preferences, and user content such as audio, video, images, holograms, three-dimensional videos, programs, applications, websites, documents, social media information, user settings, contact list, and any other information associated with the user of a mobile device. A user account may be associated with a cloud-based service for accessing the information included in the user account.

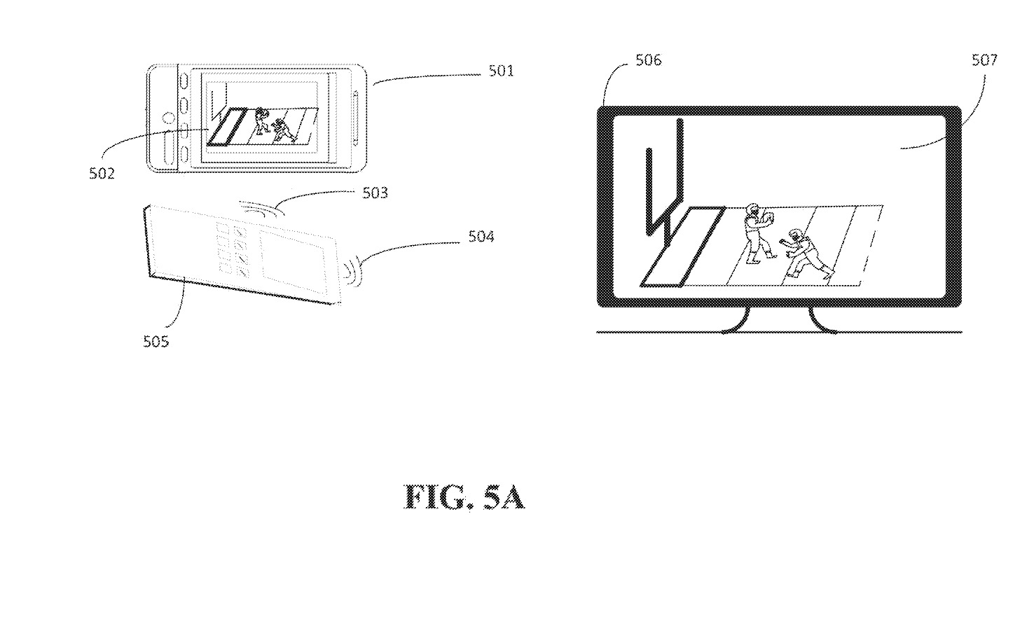

FIGS. 5A and 5B illustrate example configurations according to implementations of the disclosed subject matter. For example, John may be at his friend, Tim's house, and John may wish to play a video for Tim. As shown in FIG. 5A, the video 502 may be available from John's cloud-based account associated with his NFC capable phone 501. Tim may suggest playing the video 502 on his television 506 rather than trying to watch the video on John's phone 501. The television 506 may have an NFC remote control 505 used for controlling the television 506. John may place his phone 501 within NFC proximity of the remote control 505. As a result, the remote control 505 and the phone 501 may be connected via NFC connection 503. John may begin playing the video 502 on his phone 501 (alternatively, John may begin playing the video 502 on his phone 501 prior to connecting to the remote control 505 via NFC connection 503), and the remote control 505 may receive, via the NFC connection 503, an indication of the video 502 being played on the phone 501. The remote control 505 may transmit to the television 506, via a wireless connection 504, an instruction to retrieve a version of the video 502 being displayed on the phone 501. The instruction may instruct retrieval of a version of the video 502 from a source distinct from the phone 501. For example, the television may retrieve a full screen version of the video 507 directly from John's cloud-based account via a wired or wireless connection protocol to John's cloud-based account, instead of receiving it from the phone 501. As another example, the television may retrieve a version of the video 507 from a hosted video service accessible via the Internet. Notably, as described in further detail herein, the version retrieved by the television may be a version having a higher resolution, better quality, more extensive content, or the like, relative to the version available on the phone 501.

As shown in FIG. 5B, while viewing the full screen version of the video 507 on the television 506, John may wish to browse the web on his phone 501. The phone 501 and the remote control 505 may or may not remain connected via the NFC connection 503. While the full screen version of the video 507 is playing on the television 506, John may be able to access other content, such as a webpage 508, on his phone 501. Because the full screen version of the video 507 has been retrieved directly from John's cloud-based account, playback of the video 507 is uninterrupted while John browses the webpage 508 on his phone 501. Additionally, since John's phone 501 is not continuously streaming the video to Tim's television, depletion of John's phone battery may be avoided.

Additionally, the instruction to retrieve a version of content being displayed on a mobile device may specify retrieving the content from a source distinct from the mobile device. Specification of a source distinct from the mobile device may be based on a variety of factors including user preference, content activation device type, mobile device type, connection type, content source type, and content type. A source may be any source for content that is being displayed on a mobile device. For example, a source may be a content provider, cloud-based service, a remote source accessed via the internet, a database, a website, a user account, a network, a device, and any other source of content. In an implementation, the source may provide multiple versions of the content being displayed on the mobile device. For example, an Internet video provider may provide a mobile version, a full screen version, and an HD version of the same video. As disclosed herein, different versions of the same content may be retrieved by different devices, without requiring explicit user instruction. For example, as illustrated and described with respect to FIGS. 5A-5B, a television may retrieve a full-screen, HD version of a video that is displayed in a lower-resolution and/or smaller-size version on a phone.

In an implementation, the communication between devices and a content provider may be across one or more bridges between the interfaces. For example, the communications between the remote control, content activation device and a content provider may be managed or assisted by a third device, such as, a coordinating device, a local coordinator, a remote server, etc. In such cases, the third device may, for example, receive instructions to retrieve content displayed on a mobile device and provide the instruction to retrieve content to a content activation device. Alternatively, the third device may receive instructions to retrieve content displayed on a mobile device and may retrieve the content from a source distinct from the mobile device. The third device may then provide the content the content activation device. In an embodiment, the third device may also act as a bridge between a content provider and the content activation device when providing a second version of the content to the content activation device. Furthermore, more than one intermediate device may be implemented to facilitate communication between a content activation device, a remote control, and a content provider.

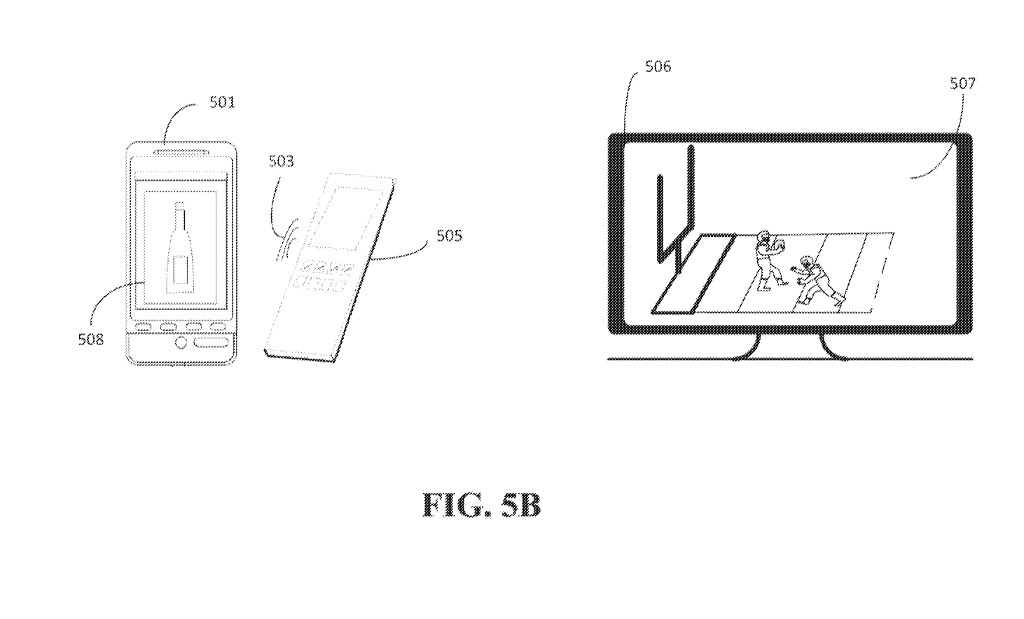

Embodiments of the presently disclosed subject matter may be implemented in and used with a variety of component and network architectures. FIG. 6 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

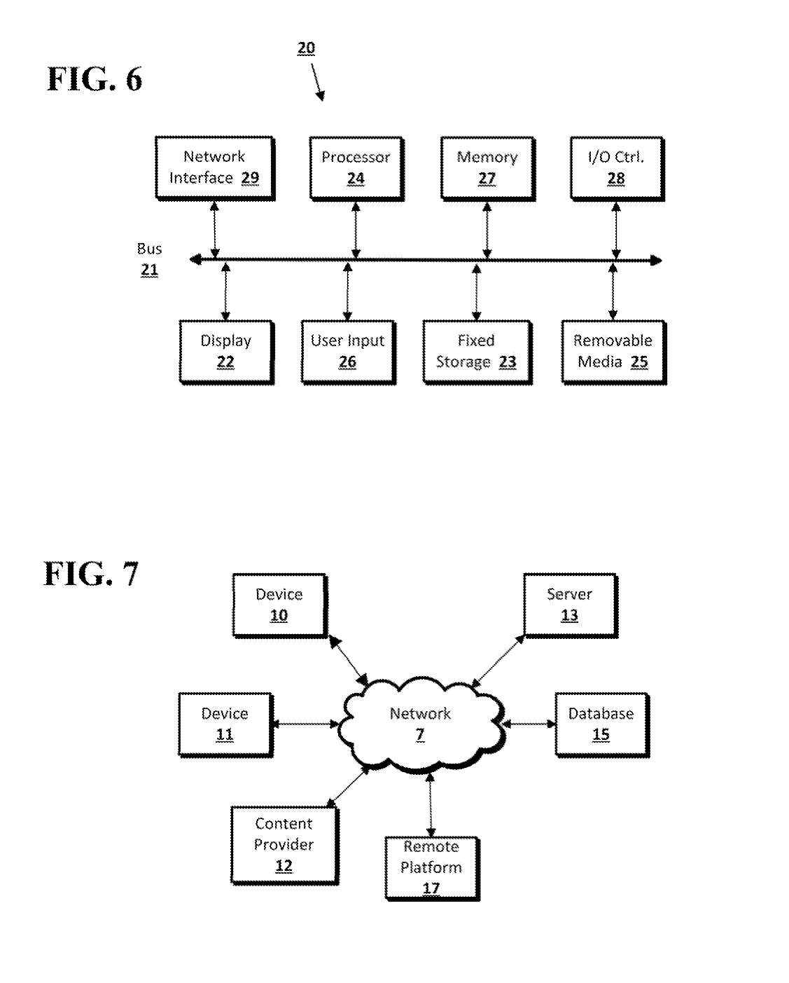

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 7.

Many other devices or components (not shown) may be connected in a similar manner (e.g., document scanners, digital cameras and so on). Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

FIG. 7 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more content providers 12, servers 13 and/or databases 15. The devices may be directly accessible by the clients 10, 11, or one or more other devices may provide intermediary access such as where content provider 12 and server 13 provide access to resources stored in a database 15. The clients 10, 11 also may access remote platforms 17 or services provided by remote platforms 17 such as cloud computing arrangements and services. The remote platform 17 may include one or more content providers 12, servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method, comprising:
connecting to a mobile device by a near field communication connection;
receiving, via the near field communication connection, an indication of content being displayed on the mobile device;
transmitting, via a wireless connection to a content activation device, an instruction to retrieve a version of the content being displayed on the mobile device, from a source distinct from the mobile device.

2. The method of claim 1, wherein the content is of a content-type selected from the group consisting of: audio, video, an image, a hologram, a three-dimensional video, a program, an application, a website, a document, and social media.

3. The method of claim 1, wherein the mobile device is selected from the group consisting of a smartphone, personal digital assistant, handheld device, handheld computer, tablet, laptop, wearable computer, and a mobile phone.

4. The method of claim 1, wherein the content activation device is selected from the group consisting of: a set top box, a television, a dock, speakers, a video player, a car audio system, a game console, and an appliance.

5. The method of claim 1, wherein the wireless connection is selected from the group consisting of: infrared, near field communications, Wi-Fi, Bluetooth, and Bluetooth light energy.

6. The method of claim 1, wherein the instruction specifies a version of the content different from the version of the content being displayed on the mobile device.

7. The method of claim 6, wherein the version of the content is selected from the group consisting of: a non-mobile version, a high-definition version, a full screen version, a mobile version, and a version having a format different from the format of the content being displayed on the mobile device.

8. The method of claim 1, wherein the source distinct from the mobile device provides multiple versions of the content being displayed on the mobile device.

9. The method of claim 1, wherein the source is selected from the group consisting of: a content provider, a cloud-based service, a remote source accessed via the internet, a database, a website, a user account, a network, and a device.

10. A method, comprising:
connecting, by a mobile device, to a remote control by a near field communication connection;
transmitting to the remote control, an instruction to retrieve a first content displayed on the mobile device, wherein the instruction to retrieve the first content is for a first version of the first content different from a second version of the first content displayed on the mobile device.

11. The method of claim 10, further comprising displaying a second content, different from the first content, on the mobile device subsequent to the step of transmitting to the remote control, an instruction to retrieve the first content displayed on the mobile device, while the first content is displayed on a content activation device controlled by the remote control.

12. The method of claim 10, wherein the content is displayed on the mobile device before the step of connecting to a remote control by a near field communication connection.

13. The method of claim 10, wherein the instruction to retrieve the first version of the first content specifies a source for the first version distinct from the mobile device.

14. The method of claim 10, wherein the first version and the second version are each independently selected from the group consisting of: a non-mobile version, a high-definition version, a full screen version, a mobile version, and a version having a format different from the format of the content being displayed on the mobile device.

15. The method of claim 13, wherein the source is selected from the group consisting of: a content provider, a cloud-based service, a remote source accessed via the internet, a database, a website, a user account, a network, and a device.

16. The method of claim 10, wherein the first content is of a content-type selected from the group consisting of: audio, video, an image, a hologram, a three-dimensional video, a program, an application, a website, a document, and social media.

17. The method of claim 10, wherein the mobile device is selected from the group consisting of a smartphone, personal digital assistant, handheld device, handheld computer, tablet, laptop, wearable computer, and a mobile phone.

18. The method of claim 11, wherein the content activation device is selected from the group consisting of: a set top box, a television, a dock, speakers, a video player, a car audio system, a game console, and an appliance.

19. The method of claim 11, wherein the content activation device is controlled by the remote control via a wireless connection selected from the group consisting of: infrared, near field communications, Wi-Fi, Bluetooth, and Bluetooth light energy.

20. The method of claim 13, wherein the source distinct from the mobile device provides multiple versions of the content being displayed on the mobile device.

21. A system, comprising:
a processor configured to:
connect to a mobile device by a near field communication connection;
receive, via the near field communication connection, an indication of content being displayed on the mobile device, and
transmit, via a wireless connection to a content activation device, an instruction to retrieve a version of the content being displayed on the mobile device, from a source distinct from the mobile device.

22. The system of claim 21, wherein the content is of a content-type selected from the group consisting of: audio, video, an image, a hologram, a three-dimensional video, a program, an application, a website, a document, and social media.

23. The system of claim 21, wherein the content activation device is selected from the group consisting of: a set top box, a television, a dock, speakers, a video player, a car audio system, a game console, and an appliance.

24. The system of claim 21, wherein the wireless connection is selected from the group consisting of: infrared, near field communications, Wi-Fi, Bluetooth, Bluetooth light energy, or other wireless connection protocol.

25. The system of claim 21, wherein the instruction specifies a version of the content different from the version of the content being displayed on the mobile device.

26. The system of claim 21, wherein the version is selected from the group consisting of: a non-mobile version, a high definition version, a full screen version, a mobile version, and a version having a format different from the format of the content being displayed on the mobile device.

27. The system of claim 21, wherein the source is selected from the group consisting of: a content provider, a cloud-based service, a remote source accessed via the internet, a database, a website, a user account, a network, and a device.

28. The system of claim 21, wherein the source distinct from the mobile device provides multiple versions of the content being displayed on the mobile device.

29. A system, comprising:
a processor configured to:
connect, by a mobile device, to a remote control by a near field communication connection, and
transmit to the remote control, an instruction to retrieve a first content displayed on the mobile device, wherein the instruction to retrieve content is for a first version of the first content different from a second version of the first content displayed on the mobile device.

30. The system of claim 29, wherein the processor is further configured to display a second content, different from the first content, on the mobile device subsequent to the step of transmitting to the remote control, an instruction to retrieve the first content displayed on the mobile device, while the first content is displayed on a content activation device controlled by the remote control.

31. The system of claim 29, wherein the instruction to retrieve the first version of the first content specifies a source for the first version distinct from the mobile device.

32. The system of claim 29, wherein the content is displayed on the mobile device before the step of connecting to a remote control by a near field communication connection.

33. The system of claim 29, wherein the instruction to retrieve the first version of the first content is an instruction to retrieve the first content from a source distinct from the mobile device.

34. The system of claim 29, wherein the first version and the second version are each independently selected from the group consisting of: a non-mobile version, a high-definition version, a full screen version, a mobile version, and a version having a format different from the format of the content being displayed on the mobile device.

35. The system of claim 33, wherein the source is selected from the group consisting of: a content provider, a cloud-based service, a remote source accessed via the internet, a database, a website, a user account, a network, and a device.
